(19) United States
(12) Patent Application Publication
(10) Pub. No.: US 2016/0114299 A1
(43) Pub. Date: Apr. 28, 2016

(54) BUCKET SKIN MIXER SYSTEM

(71) Applicant: JASON WAYNE SHALATA, Rock Springs, WY (US)

(72) Inventor: JASON WAYNE SHALATA, Rock Springs, WY (US)

(21) Appl. No.: 14/923,399

(22) Filed: Oct. 26, 2015

Related U.S. Application Data
(60) Provisional application No. 62/069,514, filed on Oct. 28, 2014.

(51) Int. Cl. B01F 13/00

(52) U.S. Cl. CPC B01F 13/0033; B01F 2215/005

(57) ABSTRACT

A bucket skin liner mix system is provided comprised of elastomer materials and having similar curvature of liner bottoms and took used for mixing. Additionally, a liner nipple is provided to conserve material and aid in cleaning mix tools.

### FIELD OF THE INVENTION

This application claims the benefit of U.S. Provisional Application No. 62/069,514, which was filed on Oct. 28, 2014. The present invention relates generally to a system for mixing construction materials, more particularly, the system comprises a nonstick modified elastomer bucket skin liner and an elastomer-coated set of tools. The system enables a user to mix construction materials effectively and efficiently.

### BACKGROUND OF THE INVENTION

It is often the case in the construction and remodeling environment that mixtures are ii unevenly mixed or not thoroughly mixed. When mixtures are placed into buckets for mixing, there are often corners of the bottom of the bucket that comprise partial dry unmixed material that is wasted. Further, most bucket systems do not allow for tools to effective access the entire bucket or bucket liner during the mixing process. Often bucket systems are not constructed in a manner to use all of the material because of the curvature of the bucket, bucket liner or tools. Mix material is wasted and not thoroughly mixed. Time, money and material is often wasted. Therefore there is a long-felt need for a more effective bucket skin system that provides for thorough mixing and conservation of mix material.

### SUMMARY OF THE INVENTION

Accordingly, it is an object of embodiments of the present invention to provide a mix system that saves materials and provides for efficient and effective mixing and handling of construction material mix selected from the group consisting of cementous materials, adhesives, epoxies, paints, dry wall, thin set, grout, patches, levelers, stucco and other construction materials used during a material mix, application and clean-up,

Additional objects, advantages and novel features of the invention will be set forth in part m the description which follows, and in part will become apparent to those skilled in the art upon examination of the following Of may be learned by practice of the invention. The objects and advantages of the invention may be realized and attained by means of the instrumentalities and combinations particularly pointed out in the appended claims. To achieve the foregoing and other objects, and in accordance with the purposes of the present invention, as embodied and broadly described herein, the invention comprises A bucket skin mixer system comprising a bucket skin adapted for containing a construction material mix and at least one tool for manipulating the construction material mix, said bucket skin, liner adaptable to fit inside a commercial construction bucket and said bucket skin liner comprising an elastomeric material and having an upper lip portion, a bottom portion, a wall portion between the upper lip portion and the bottom portion and having an internal predetermined curvature between the wall portion and the bottom portion, said at least one tool having a distal end comprising a blade that contacts the construction material mix and said bucket skin liner during a mixing action, said blade comprising the same curvature as the curvature as the internal predetermined curvature between the wall portion and the bottom portion of the bucket skin liner.

In another embodiment, the invention comprises a bucket skin mixer system comprising a bucket skin adapted for containing a construction material mix and at least one tool for manipulating the construction material mix, said bucket skin liner adaptable to fit inside a commercial construction bucket and said bucket skin liner comprising an elastomeric material and having an upper lip portion, a bottom portion, a wall portion between the upper lip portion and the bottom portion and having an internal predetermined curvature between the wall portion and the bottom portion, the upper lip portion comprises a protruding nipple portion disposed atop the upper lip portion. And said at least one tool having a distal end comprising a blade that contacts the construction material mix and said bucket skin liner during a mixing action, said blade comprising the same curvature as the curvature as the internal predetermined curvature between the wall portion and the bottom portion of the bucket skin liner and the distal end of the at least one tool is comprised of the elastomeric material.

Benefits and advantages of the present invention include, but are not limited to, providing an effective and efficient means to mix materials saving time, money and materials.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view one embodiment of a portion of the instant invention comprising a bucket and a bucket liner.

FIG. 2 illustrates a side cross sectional planar view of one embodiment of the instant invention as shown in FIG. 1.

FIG. 3 illustrates a side cross sectional planar view of one embodiment of the instant invention wherein the bucket liner is inside the bucket.

FIG. 4 illustrates an embodiment of the instant invention, wherein the bucket skin liner and two tools are included.

FIG. 5 illustrates the upper lip portion of the bucket skin liner having a protruding nipple.

FIG. 6 illustrates the protruding nipple in contact with the tool during the removal of mix material.

FIG. 7 illustrates the nipple cleaning the tool through contact

### DETAILED DESCRIPTION OF THE INVENTION

Reference will now he made in detail to embodiments of the invention, examples of which are illustrated in the accompanying drawings. Throughout the following detailed description, the same reference characters refer to the same or similar elements in all figures.

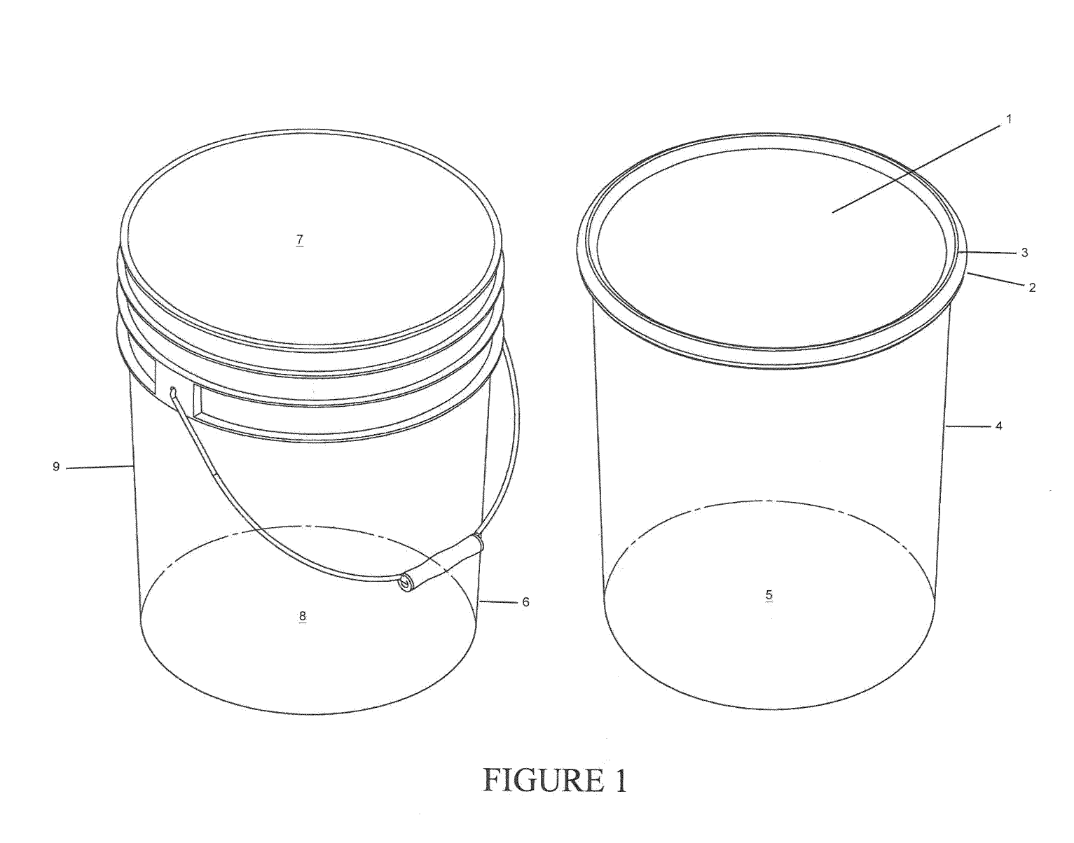

At the left portion of FIG. 1, a commercial or contractor bucket 6 is depicted. For purposes of this invention, the bucket skin mixer system is independent of size and can accommodate 1, 3, 3.5, 5, 8, 10 and 15 gallon buckets or any other size commercial sized bucket. The commercial bucket has in internal surface 7 that contact materials held in the bucket, a bucket bottom 8 and walls 9. At the left of FIG. 1, a bucket skin, liner 1 is depicted. The bucket skin liner 1 comprises a bottom 5, walls 4 and upper lip 2. The upper lip 2 further comprises a nipple 3 disposed atop the upper lip of the bucket skin line 1.

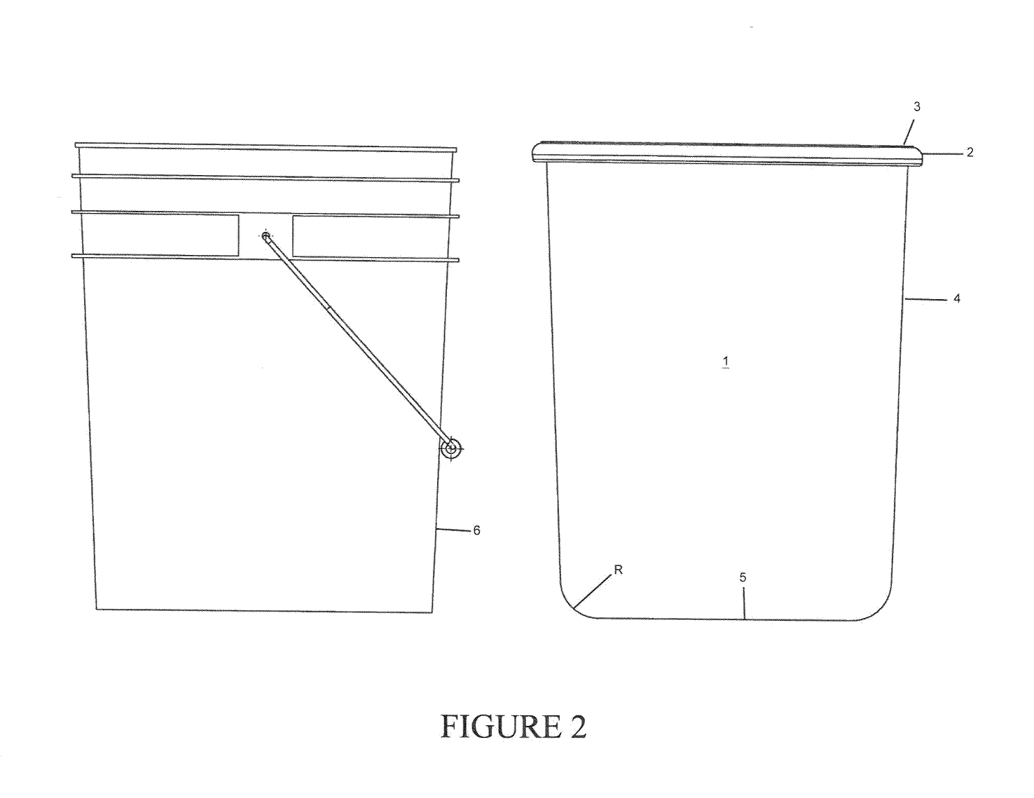

FIG. 2 depicts a planar cross sectional of the objects depicted in FIG. 1. In this cross sectional view, the internal predetermined curvature R of the bucket liner is shown at the intersection of the bottom 5 and wall of the bucket skin liner. The internal predetermined curvature R is constant between the material of the bottom 5 and the wall 4 and around the entire bottom.

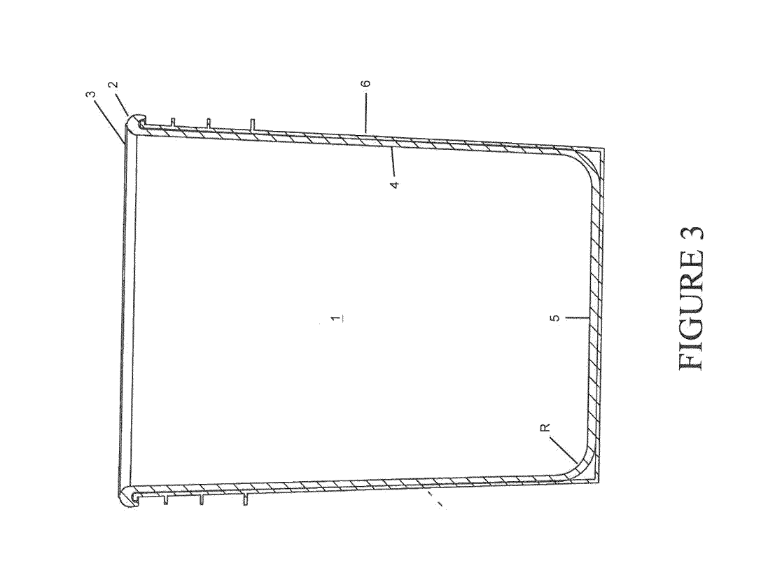

FIG. 3 depicts the bucket skin liner 1 with internal predetermined curvature R between the bottom 5 and wall 4 inside the bucket walls 6. In this embodiment, the bucket skin liner is disoposed inside the the bucket 6 with the internal bucket bottom surface in contact with tehexternal bucket skin liner. The upper lip of portion fits over the top of the bucket 6.

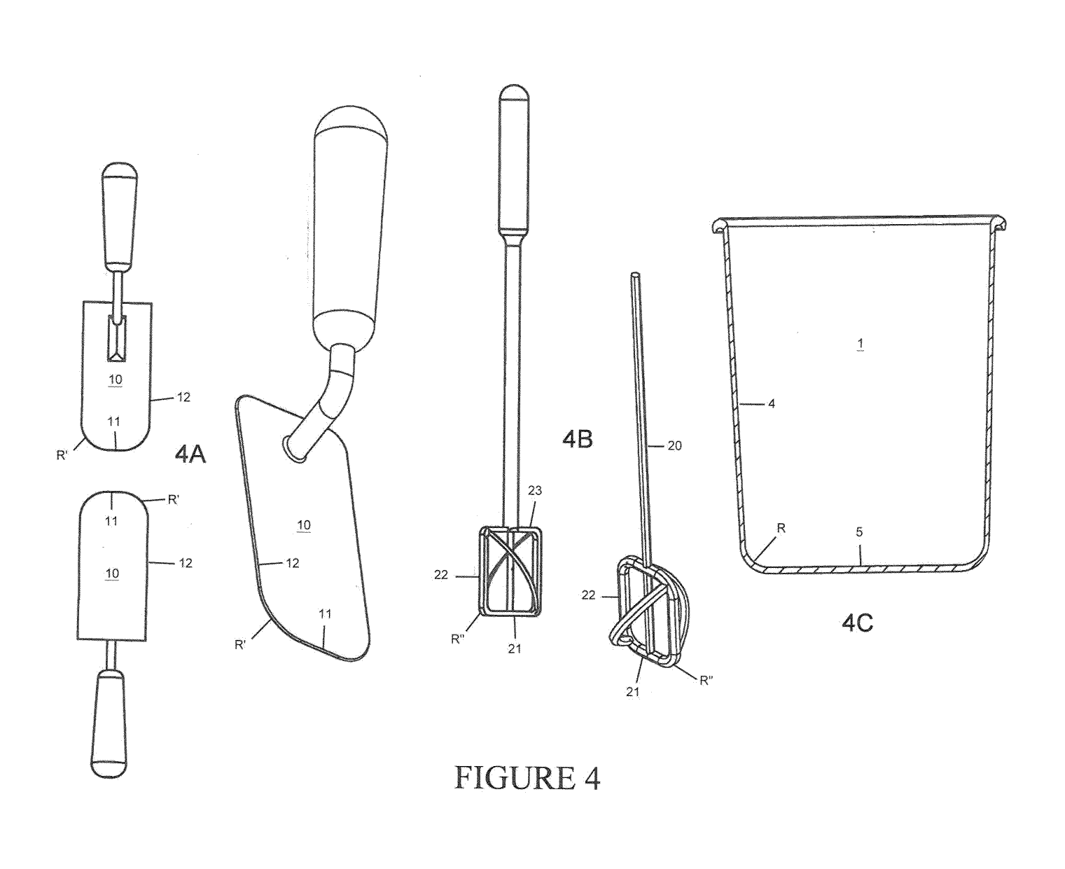

FIG. 4 depicts examples of two bladed tools, a trowel 10 and bladed agitator 20, and bucket skin liner 1 having internal predetermined curvature R between the bottom 5 and the walls 4. The trowel 10 has a handle portion and a distal end. In actual use, the distal end makes contact with the construction material mixes in the bucket sin liner and often the bucket skin liner itself. The distal end is has bladed portion having a bottom portion 11 and side portion 12. The bladed portion has a curvature R′ between the bottom portion 11 and the side portion 12. The trowel bladed curvature R′ is the same curvature as the internal predetermined curvature of the bucket skin liner R.

FIG. 4 also depicts a bladed agitator 20 between the bucket skin liner and the trowel. The bladed agitator 20 has a handle portion and a distal end. In actual use, the distal end makes a contact with the construction material mixes in the bucket sin liner and often the bucket skin liner itself. The outer most blades of the bladed agitator 20 have a bottom blade 21 and side blades 22 with a curvature R″ therebetween. The curvature R″ is the same curvature as the internal predetermined curvature of the bucket skin liner R. The matched curvature of R with either R′ or R″ comprises a mix system to thoroughly and effectively mix dry materials.

By matching the curvature of the blades of the trowel or the bladed agitator with the curvature of the bottom of the bucket skin liner there is efficient effective mixing and less loss of construction material mix. It has been demonstrated that significantly less material remains dry during mixing of construction material mixes, including any mixes selected from the group consisting of cementous materials, adhesives, epoxies, paints, dry wall, thin set, grout, patches, levelers, stucco and other construction materials used during a material mix, application and clean-up. Further, the mixing is more uniform since no material remains between the blade edges of tool and the internal surface of the bucket skin liner, particularly in and around the area of the internal predetermined curvature of the bucket skin liner during the mix action or application action. This contributes to significant cost savings and conservation of material. Additionally, the cleanup is easier with less powder or semi wet material remaining.

Another important feature of the bucket skin mixer system is that both the bucket skin and the at least one tool is comprised of an elastomeric material. The elastomeric material is selected from any material of the group consisting of urethane, silicone, plastic, rayon synthetic materials, and metamaterials. The elastomeric material must be sufficiently robust and pliable to withstand mechanical mixing and continuous mixer and trowel impact. In many embodiments of the bucket skin liner mixer system, a tool, trowel blade or blade of bladed agitator is comprised of a elastomeric material coating, such that the underlying tool is comprised of metal or similar material and the coating is of elastomeric material.

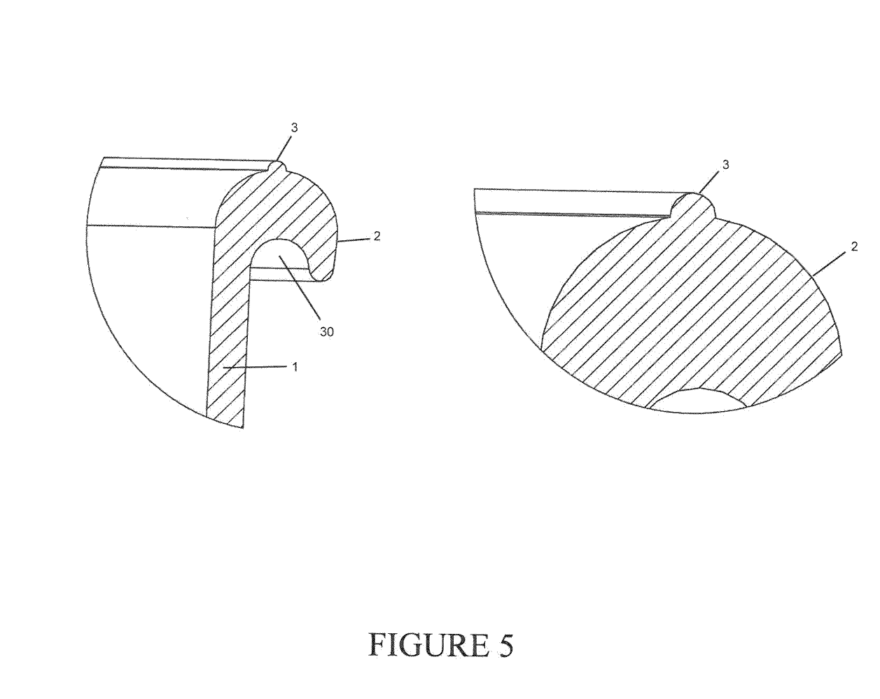

FIG. 5 depicts the upper lip portion 2 of the bucket skin liner 1. A nipple portion 3 is disposed atop the upper lip portion 2. The nipple portion may be disposed atop the entire perimeter of the top of the upper lip portion, or alternatively, may only partially cover the perimeter portion of the upper lip portion. The nipple portion provides a wiper to aid in the removal of material off the blades and edges of the tools used to mix or apply the material. Also depicted in FIG. 5 is an extended and downward-curved portion 30 of the upper lip portion 2, This extended and downward-curved portion 30 allows the bucket skin liner 1 to encapsulate the top of the bucket for more effective gripping of the bucket and remain securely attached during mixing operations and mixing action.

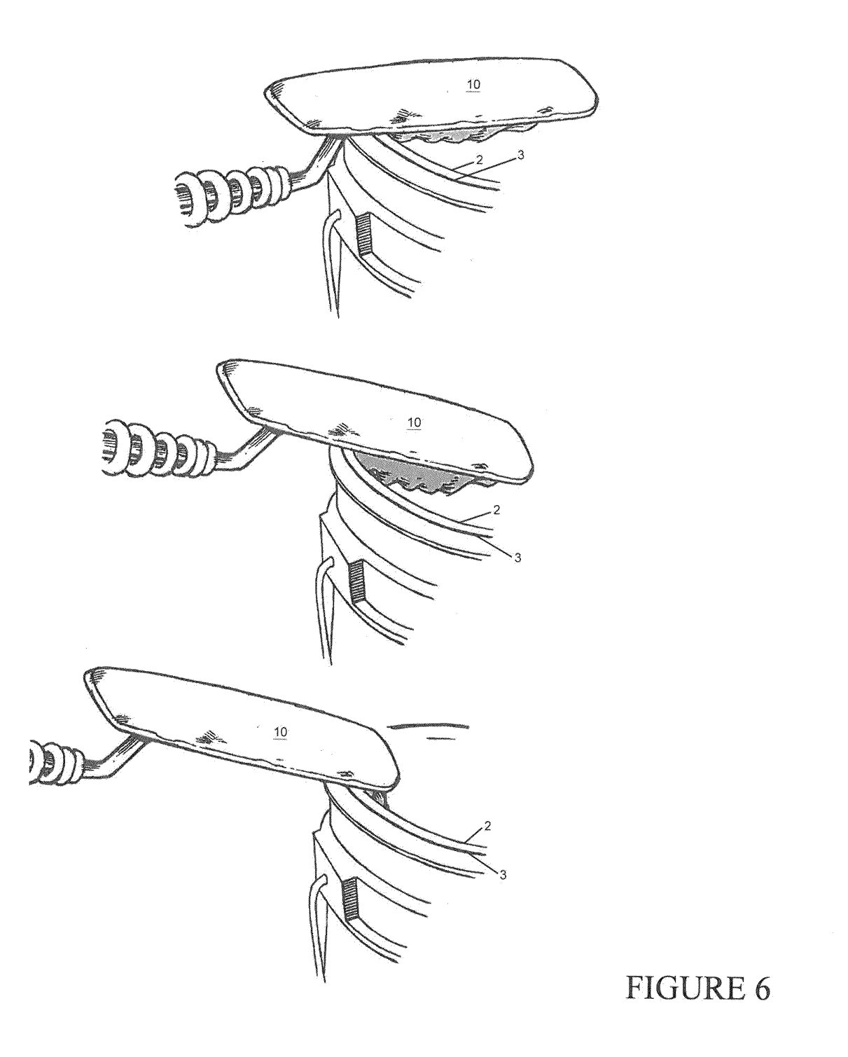

FIG. 6 shows the nipple portion 3 disposed atop the upper lip portion 2 cleaning and wiping of mix material off a trowel 10, The nipple portion effectively conserves material thereby reducing costs.

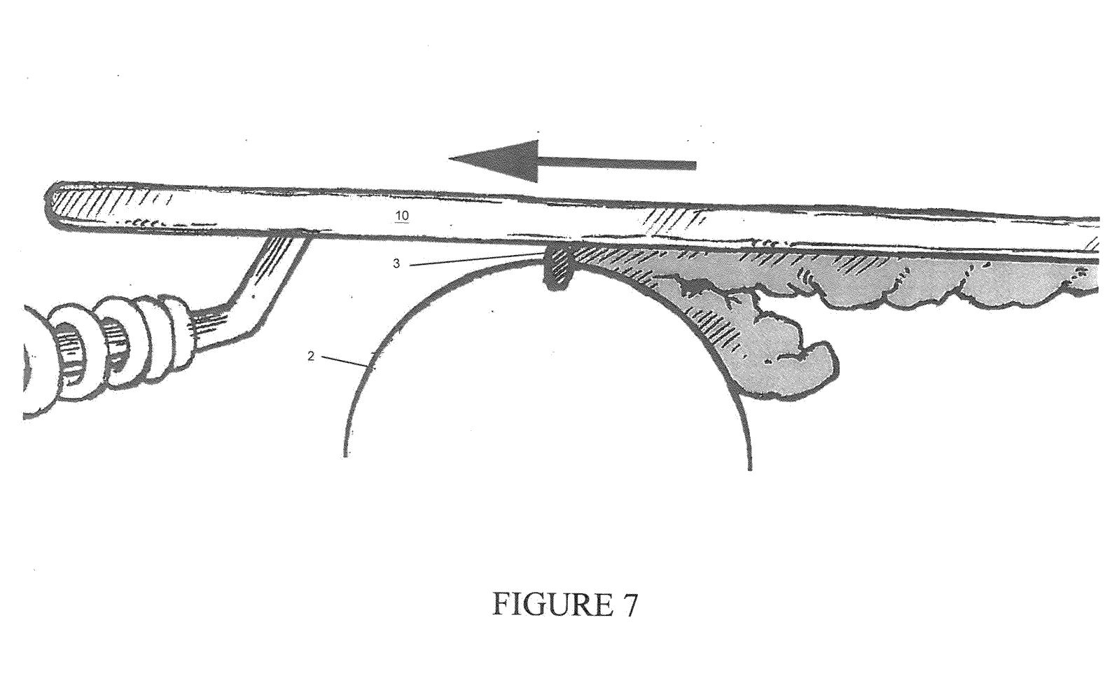

FIG. 7 shows the trowel being cleaned by the nipple, with the arrow depicting the motion of the tool over the nipple.

It is believed that the apparatus of the present invention and many of its attendant advantages will be understood from the foregoing, description. It is also believed that it will be apparent that various changes may he made in the form, geometry, construction, and arrangement of the components without departing from the scope and spirit of the invention and without sacrificing its material advantages. The forms described are merely exemplary and explanatory embodiments thereof. It is the intention of the following claims to encompass and include such changes.

What is claimed:

1. A bucket skin mixer system comprising a bucket skin adapted for containing a construction material mix and at least one tool for manipulating the construction material mix, said bucket skin liner adaptable to fit inside a commercial construction bucket and said bucket skin liner comprising an elastomeric material and having art upper lip portion, a bottom portion, a wall portion between the upper lip portion and the bottom portion and having an internal predetermined curvature between the wall portion and the bottom portion, said at least one tool having a distal end comprising a blade that contacts the construction material mix and said bucket skin liner during a mixing action, said blade comprising the same curvature as the curvature as the internal predetermined curvature between the wall portion and the bottom portion of the bucket skin liner.

2. The bucket skin mixer system of claim 1, wherein the distal end of the at least one tool is comprised of the elastomeric material.

3. The bucket skin mixer system of claim 1, wherein the distal end of the at least one tool is coated with the elastomeric material.

4. The bucket skin mixer system of claim 1, wherein the elastomeric material is selected from any material of the group consisting of urethane, polyurethane, silicone, plastic, rayon synthetic materials, and metamaterials.

5. The bucket skin mixer system of claim 1, wherein the elastomeric material comprises urethane.

6. The bucket skin mixer system of claim 1, wherein the elastomeric material comprises polyurethane.

7. The bucket skin mixer system of claim 1, wherein the upper lip portion further comprises a protruding nipple portion disposed atop the upper lip portion.

8. The bucket skin mixer system of claim 1, wherein the at least one tool comprises a trowel.

9. The bucket skin mixer system of claim 1, therein the at least one tool comprises a bladed agitator.

10. The bucket skin mixer system of claim 1, wherein the upper lip portion comprises an extended and downward-curved portion to encapsulate the commercial construction bucket.

11. The bucket skin mixer system of claim 1, wherein the construction material mix is selected from the group consisting of cementous materials, adhesives, epoxies, paints, dry wall, thin set, grout, patches, levelers, stucco and other construction materials used during a material mix, application and clean-up.

12. The bucket skin mixer system of claim 1, wherein the commercial construction bucket is selected form the group consisting of 1, 3, 3.5, 5, 8, 10 and 15 gallon buckets.

13. A bucket skin mixer system comprising a bucket skin adapted for containing a construction material mix and at least one tool for manipulating the construction material mix, said bucket skin liner adaptable to fit inside a commercial construction bucket and said bucket skin liner comprising an elastomeric material and having an upper lip portion, a bottom portion, a wall portion between the upper lip portion and the bottom portion and having an internal predetermined curvature between the wall portion and the bottom portion, said at least one tool having a distal end comprising a blade that contacts the construction material mix and said bucket skin liner during a mixing action, said blade comprising the same curvature as the curvature as the internal predetermined curvature between the wall portion and the bottom portion of the bucket skin liner and the distal end of the at least one tool is comprised of the elastomeric material.

14. The bucket skin mixer system of claim 13, wherein the elastomeric material is selected from any material of the group consisting of urethane, polyurethane, silicone, plastic, rayon synthetic materials, and metamaterials.

15. The bucket skin mixer system of claim 13, wherein the distal end of the at least one tool is coated with the elastomeric material.

16. The bucket skin mixer system of claim 13 wherein the distal end of the at least one tool is coated with the elastomeric material.

17. The bucket skin mixer system of claim 13, wherein the upper lip portion further comprises a protruding nipple portion disposed atop the upper up portion.

18. A bucket Skin mixer system comprising a bucket skin adapted for containing a construction material mix and at least one tool for manipulating the construction material mix, said bucket skin liner adaptable to fit inside a commercial construction bucket and said bucket skin litter comprising an elastomeric material and having an upper lip portion, bottom portion, a wall portion between the upper lip portion and the bottom portion and having an internal predetermined curvature between the wall portion and the bottom portion, the upper lip portion comprises a protruding nipple portion disposed atop the upper lip portion. And said at least one tool having a distal end comprising a blade that Contacts the construction Material Mix and said bucket skin liner during a mixing action, said blade comprising the same curvature as the curvature as the internal predetermined curvature between the wall portion and the bottom portion of the bucket skin liner and the distal end of the at least one tool is comprised of the elastomeric material.

19. The bucket skin mixer system of claim 18, wherein the elastomeric material is selected from any material of the group consisting of urethane, polyurethane, silicone, plastic, rayon synthetic materials, and metamaterials.

20. The bucket skin mixer system of claim 18, wherein the distal end of the at least one tool is coated with the elastomeric material.
